(19) United States
(12) Patent Application Publication
(10) Pub. No.: US 2011/0245946 A1
(43) Pub. Date: Oct. 6, 2011

(54) LOW POWER AUDIO PLAY DEVICE AND METHOD

(76) Inventors: Boo-Jin KIM, Suwon-si (KR); Jeongbae SEO, Yongin-si (KR)

(21) Appl. No.: 13/075,459

(22) Filed: Mar. 30, 2011

(30) Foreign Application Priority Data
Apr. 1, 2010 (KR) 10-2010-0029747

(51) Int. Cl. G06F 17/00; G06F 1/32

(52) U.S. Cl. 700/94; 713/320

(57) ABSTRACT

A low power audio play device, including an audio processing unit configured to decode requested audio data, the audio processing unit buffering decoded requested audio data as buffered data, and an audio output unit configured to play the buffered data when the buffered data in the audio processing unit are more than a predetermined amount, wherein a supply of power to hardware is configured to be cut off, except for power supplied to the audio output unit, while the buffered data are played.

### BACKGROUND

1. Field

Embodiments relate to a low power audio play device and associated method.

2. Description of the Related Art

With developments of digital multimedia related technology, audio play devices for playing a digitalized sound are widely used. As an audio play device, there are, e.g., a compact disk (CD) player, a digital versatile disk (DVD) audio player, a mini disk (MD) player, an MP3 player, etc. An audio play device may be, e.g., a flash memory type (using a flash memory as a main storage device), a hard disk type (using a hard disk as a main storage device), etc. The flash memory type may be small, fast, and impact-resistant, but may be expensive in terms of storage capacity, whereas the hard disk type may be inexpensive for a same capacity. However, a hard disk type may be bulky size and relatively slow compared to the flash memory type.

### SUMMARY

An embodiment is directed to a low power audio play device, including an audio processing unit configured to decode requested audio data, the audio processing unit buffering decoded requested audio data as buffered data, and an audio output unit configured to play the buffered data when the buffered data in the audio processing unit are more than a predetermined amount, wherein a supply of power to hardware is configured to be cut off, except for power supplied to the audio output unit, while the buffered data are played.

The audio processing unit may be configured to periodically generate a notification signal per a predetermined period and synchronize the requested audio data with audio data played through the audio output unit.

The audio processing unit may include a main storage unit configured to store audio data, a central processing unit configured to receive the requested audio data from the main storage unit, the central processing unit decoding the received requested audio data, and a buffer configured to buffer the decoded requested audio data according to a control of the central processing unit, the buffer providing the buffered data to the audio output unit when the buffered data are more than a predetermined amount. Power supplied to the audio processing unit may be cut off when the buffered data are provided from the buffer to the audio output unit.

The audio processing unit may further include a direct memory access (DMA) controller, the DMA controller being configured to control provision of the buffered data to the audio output unit without passing the buffered data through the central processing unit.

The central processing unit may include a driver configured to control to play of the buffered data according to an operating mode, the operating mode including a normal power audio mode and a low power audio mode, and a power management unit, the power management unit being configured to cut off the supply of power to hardware unrelated to audio playing according to a control of the driver while the buffered data are played in the low power audio mode.

The driver may include a data receiving unit configured to receive the requested audio data from an application layer, the application layer being a layer upper to the driver, a rendering control unit configured to provide the buffered data to the audio output unit after a predetermined amount of the requested audio data that is provided from the application layer is buffered, a notification control unit configured to periodically provide a notification signal to the application layer per a predetermined period while the buffered data are played through the audio output unit, and a low power audio control unit for controlling a power supply operation of the power management unit according to the operating mode.

The notification control unit may be configured to analyze the data buffered in the buffer and change a setting value of a time based on an analysis result, the notification signal being provided to the application layer according to the setting value.

The buffer may include a circular buffer.

The audio output unit may include an output data storage unit, the output data storage unit being configured to receive the buffered data from the buffer and store the buffered data.

When a remaining capacity of data stored in the output data storage unit is less than a reference value, power may be resupplied to the audio processing unit.

When a remaining capacity of data stored in the output data storage unit is less than a reference value, data buffered in the buffer may be additionally provided to the output data storage unit.

After the buffered data are additionally provided from the buffer to the output data storage unit, power supplied to the audio processing unit may be cut off.

Another embodiment is directed to a low power audio play method, the method including decoding requested audio data, buffering the decoded requested audio data as buffered data, playing the buffered data if the buffered data is more than a predetermined amount, and cutting off power supply of a hardware region irrelevant to the playing operation among a plurality of hardware regions in the audio play device while the buffered data are played.

The method may further include changing a setting value of a timer by analyzing the buffered data, and periodically generating a notification signal to an application layer per a predetermined period through the timer while the buffered data are played.

The cutting off of the power supply of the hardware region may be performed by a control of a driver layer, the driver layer being lower than an application layer.

The playing of the buffered data may include storing the buffered data in an audio output unit when the buffered data is more than a predetermined amount, and playing the data stored in the audio output unit. Power supply may be cut off to hardware, except the audio output unit, while the buffered data are played.

The method may further include, when a remaining capacity of data stored in the output data storage unit is less than a reference value, re-supplying power to hardware to which the power supply had been previously cut off, and providing additional buffered data from the buffer to the audio output unit, wherein, after the additional buffered data are provided from the buffer to the audio output unit, power supply to hardware, except the audio output unit, may be cut off again.

Another embodiment is directed to a low power audio play method, the method including decoding audio data in response to a request generated through an application layer according to a user request, buffering a decoding result in a circular buffer, storing the buffered data in an audio output unit when the data buffered in the circular buffer are more than a predetermined amount, periodically providing a notification signal to an audio middleware layer and the application layer, the notification signal representing that a rendering operation about the data stored in the audio output unit is completed, cutting off power supply to hardware except the audio output unit, and playing the data stored in the audio output unit.

The method may further include changing a setting value of a timer by analyzing the buffered data, and periodically generating the notification signal to the audio middleware layer and the application layer through the timer while the buffered data are played.

Another embodiment is directed to a low power audio play device, including a decoding means for decoding audio data in response to a request generated through an application layer according to a user request, a buffering means for buffering a decoding result in a circular buffer, a storage means for storing the buffered data in an audio output unit when the data buffered in the circular buffer are more than a predetermined amount, a notification means for periodically providing a notification signal to an audio middleware layer and the application layer, the notification signal representing that a rendering operation for the data stored in the audio output unit is completed, a power supply control means for cutting off power supply to hardware except the audio output unit, and a playing means for playing the data stored in the audio output unit.

### BRIEF DESCRIPTION OF THE DRAWINGS

The above and other features and advantages will become more apparent to those of skill in the art by describing in detail example embodiments with reference to the attached drawings, in which:

FIG. 1 illustrates a block diagram of a configuration of a low power audio play device 1000 according to an embodiment;

FIG. 2 illustrates a block diagram of an audio play operation of the low power audio play device 1000 according to an embodiment;

FIG. 3 illustrates a view of a structure of a circular buffer 180 and an SRAM 280 shown in FIGS. 1 and 2;

FIG. 4 illustrates a view of a hierarchical structure of low power driving software for implementing a method according to an embodiment;

FIG. 5 illustrates a view of a detailed configuration of an I2S driver shown in FIG. 4;

FIG. 6 illustrates a view of a notification signal occurrence operation of a timer 190 according to an embodiment;

FIG. 7 illustrates a flowchart of a low power driving method of a low power audio play device according to an embodiment;

FIG. 8 illustrates a view of a method of buffering audio data in a circular buffer 180 in operation S1300 of FIG. 7; and

FIG. 9 illustrates a view of a method of transmitting audio data from the circular buffer 180 to the I2S device 210 in operation S1400 of FIG. 7.

### DETAILED DESCRIPTION

Korean Patent Application No. 10-2010-0029747, filed on Apr. 1, 2010, in the Korean Intellectual Property Office, and entitled: “Low Power Audio Play Device and Method,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art. In the drawing figures, the dimensions of layers and regions may be exaggerated for clarity of illustration. Like reference numerals refer to like elements throughout.

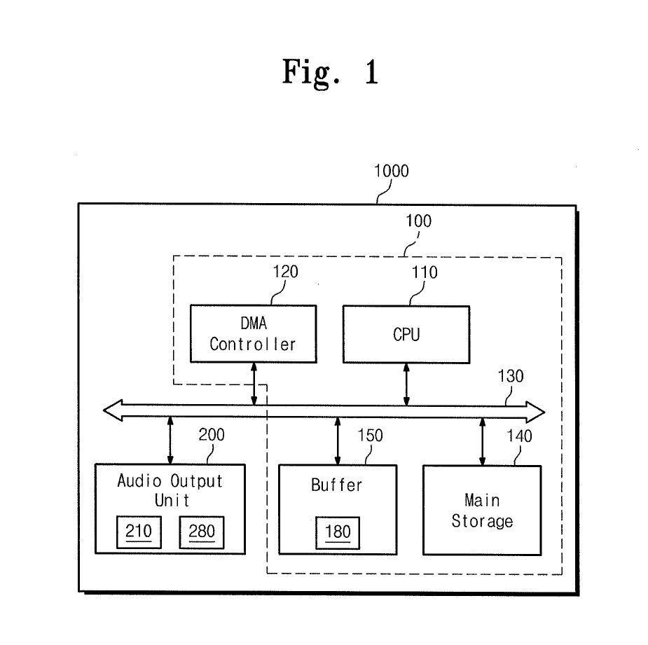

FIG. 1 illustrates a block diagram of a configuration of a low power audio play device 1000 according to an embodiment.

Referring to FIG. 1, the low power play device 1000 may include an audio processing unit 100 and an audio output unit 200.

The audio processing unit 100 may perform a read/write/erase function on audio data. Also, the audio processing unit 100 may perform a compressing or encoding function, and a decompressing or decoding function, on audio data, and also perform various sound effects functions on audio data. Besides that, the audio processing unit 100 may perform a data management function on audio data, and may control a data input/output operation on a storage medium (for example, a main storage unit and a buffer memory) for storing audio data.

The audio processing unit 100 may decode audio data requested by a user and provide the decoded audio data to an audio output unit 200. An output device (not shown) such as a speaker, an earphone, a headphone, etc., may be connected to the audio output unit 200 such that audio data provided from the audio output unit 200 can be played or outputted.

A decoding operation and a function for sound effects on audio data may all be processed in the audio processing unit 100. The audio output 200 may perform a function for playing or outputting audio data provided from the audio processing unit 100 through an output device.

As will be described in more detail below, the low power audio device 1000 may not instantly provide audio data processed in the audio processing unit 100 to the audio output unit 200. Rather, the low power audio device 1000 may buffer the processed audio data in the audio processing unit 100. Whenever the buffered audio data become more than a predetermined amount, they may be provided from the audio processing unit 100 to the audio output unit 200.

In this case, since processing for audio data to be played is already completed in the audio processing unit 100, while the audio data are played or outputted through the audio output unit 200, the audio processing unit 100 may not be needed. Accordingly, the low power audio play device 1000 may turn off the audio processing unit 100 while audio data are played or outputted, such that power consumption can be reduced. In an implementation, a region to which the audio play device 1000 provides power may be limited, e.g., limited to hardware that is directly related to playing or outputting of audio data.

According to the above configuration, based on an operation state of the audio play device 1000, power supply may be partially turned on or off according to a hardware region of the audio play device 1000. Thus, during playing of the audio data, power consumption of the audio play device 1000 may be minimized.

According to an embodiment, the power management method may be configured so that it is not subject to an application platform (that is, is not dependant on the application platform). Thus, the power management may control power supply of the audio play device 1000 by its own function. Therefore, low power consumption of the audio play device 1000 may be easily achieved without changing hardware of a typically audio play device.

Details of an example configuration of the low power audio play device 1000 according to an embodiment will now be provided.

In the present example embodiment, the audio processing unit 100 includes a central processing unit (CPU) 110, a direct memory access (DMA) controller 120, a bus 130, a main storage 140, and a buffer 150.

The CPU 110 may be referred to as a microcomputer unit (MCU) or micro processor user (MPU). The CPU 110 is connected to the main storage unit 140, the buffer 150, and the audio output unit 200 through the bus 130, to control general operations of the audio processing unit 100. Through hardware and/or software configuration embedded in the CPU 100, the CPU 100 may perform a read/write/erase function for audio data, a compressing or encoding function for audio data, a function for decompressing or decoding the compressed or encoded audio data into an original state, and various sound effects on audio data. A configuration (hereinafter referred to as low power driving software) for controlling to turn off power of hardware that is not directly related to a playing operation of audio data may be embedded in the CPU 110.

The DMA controller 120 may control the performance of audio data transmission between the main storage unit 140 and the buffer 150 without going through the CPU 110. Moreover, the DMA controller 120 controls transmission of audio data between the buffer 150 and the audio output unit 200 without passing it through the CPU 110. In a preferred embodiment, the DMA controller 120 includes a plurality of communication paths (for example, a plurality of DMA channels), and thus may control data transmission with respect to a plurality of memory chips constituting the main storage unit and the buffer 150.

The main storage unit 140 may be used as a main storage device for storing a large amount of data. The main storage unit 140 may store data (for example, audio data) using, e.g., a hard disk drive (HDD) and/or semiconductor memory chips. A plurality of channels (for example, a number N) may be configured between the DMA controller 120 and the main storage unit 140.

In the present example embodiment, a main storage unit 140 including a flash memory will be described as an example. However, a memory used for the main storage unit 140 is not limited to a specific type or form, and thus may be of various kinds of types or forms, e.g., among nonvolatile memories. For example, a memory applied to the main storage unit 140 may include a nonvolatile memory such as MRAM and PRAM, besides a flash memory. Additionally, a memory applied to the main storage unit 140 may include a volatile memory such as DRAM. In an implementation, the main storage unit 140 may be configured with a mixed form of at least one nonvolatile memory and at least one volatile memory. In an implementation, the main storage unit 140 may be configured with a mixed from of at least two kinds of nonvolatile memories.

Furthermore, the number of data bits stored in each memory cell of memories constituting the main storage unit 140 may be configured with various forms. For example, a flash memory may store 1-bit data on one memory cell, or may store a plurality of bit data (for example, 2 or more bits) on one memory cell. A memory cell for storing 1-bit data per cell may be referred to as a single-bit cell or a single-level cell (SLC). A memory cell for storing a plurality of bit data per cell may be referred to as a multi-bit cell, a multi-level cell (MLC), or a multi-state cell.

Furthermore, the types of memory cells constituting flash memories may vary. For example, a flash memory may be configured with one or more of a NAND flash memory, a NOR flash memory, an One_NAND flash memory (in which a flash memory core and a memory controller are integrated into a single chip), etc. Moreover, flash memories may be configured with a hybrid form, in which flash memories of two or more types are mixed. Also, a structure of a charge storage layer of a flash memory cell may vary. For example a charge storage layer of a memory cell may include a conductive floating gate or a charge storage layer such as Si₃N₄, Al₂O₃, HfAlO, and HfSiO (particularly, a layer with a charge trapping site). A flash memory structure using the above layer as a charge storage layer may be referred to as a charge trap flash (CTF).

In the present example embodiment, the buffer 150 may temporarily store data that are transmitted between the DMA controller 120 and the main storage unit 140, or data that are transmitted between the CPU 110 and the main storage unit 140. The data may include audio data and additional data related to the audio data, e.g., metadata such as tags, etc. The buffer 150 may include random-access memories. In an embodiment, the buffer 150 includes a DRAM.

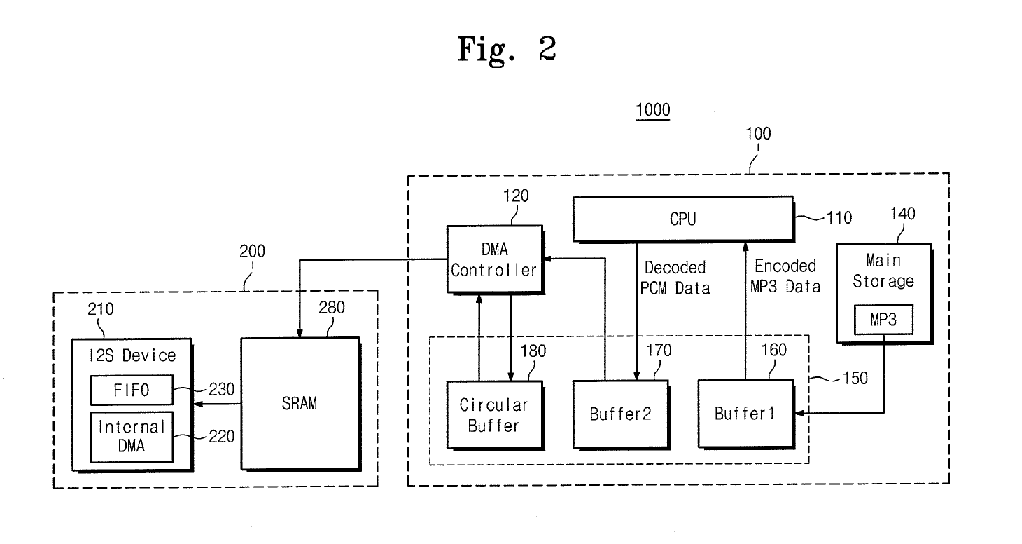

In the present example embodiment, the buffer 150 includes a circular buffer 180 and buffers audio data processed in the CPU 110. The circular buffer 180 may be referred to as a cyclic buffer or a ring buffer. The audio data processed in the audio processing unit 100 may not be instantly provided to the audio output unit 200, but instead may be buffered in the circular buffer 180 until the processed data reach a predetermined amount. Then, once the audio data buffered in the circular buffer 180 reach a predetermined amount, the buffered audio data are provided from the circular buffer 180 to the audio output unit 200. A detailed configuration and example operations of the buffer 150 will be described in more detail below with reference to FIG. 2.

The audio output unit 200 may include an I2S (“Integrated Interchip Sound” or IIS) device 210 and an output data storage unit 280. The output data storage unit 280 may include a high-speed accessible SRAM. An audio output device (not shown) such as a speaker, an earphone, and a headphone may be connected to the I2S device 210 through an I2S interface method. According to an embodiment, in order to prevent data loss of the audio data, a case that the I2S interface method is applied will be described as one example. However, this is just one example to which the inventive concept is applied, and thus various forms of interface methods may be applied between the audio output unit 200 and an output device.

The audio data buffered in the circular buffer 180 may be provided to the SRAM 280 of the audio output unit 200. A decoding operation and sound effects of the audio data provided to the SRAM 280 may be already completed in the audio processing unit 100. Therefore, the audio data provided to the SRAM 280 may be played or outputted through the audio output unit 200 without additional data processing.

In a preferred embodiment, the SRAM 280 may be configured with a data storage capacity that is a smaller than or identical to the data storage capacity of the circular buffer 180. Once audio data are provided from the circular buffer 180 to the SRAM 280, hardware (for example, the audio processing unit 100) that is not directly related to playing or outputting the audio data can be turned off. During this state, the audio data of the SRAM 280 may be played or outputted externally through an output device such as a speaker, an earphone, and headphone, which is connected to the I2S device 100. It will be understood that “off” in this context may be, e.g., a deep idle mode, and the hardware that is turned off may respond to a predetermined signal or signals, e.g., an interrupt, as one of skill in the art would understand. These and other aspects are described in further detail below.

According to this configuration, power may be applied to some subset of hardware components (for example, the audio output unit 200) that are directly related to the playing or outputting the audio data during playing of the audio data. Accordingly, power consumption of the audio play device 1000 may be minimized through a low power audio play operation. For an audio play device, e.g., a portable electronic device, that is sensitive to power consumption, embodiments may provide a significant power consumption reduction effect.

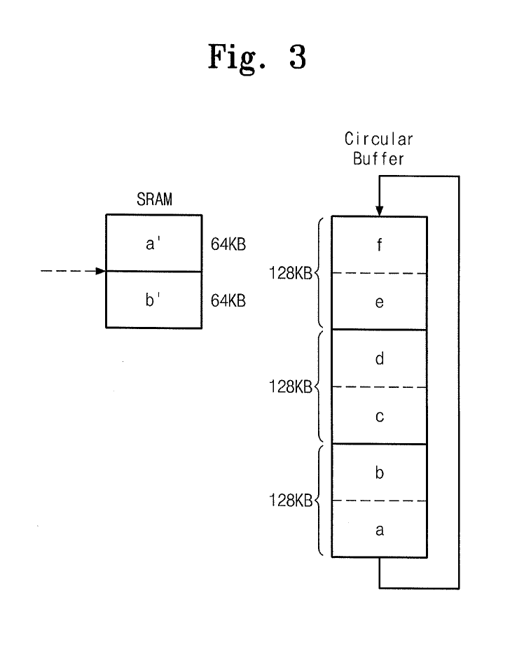

FIG. 2 illustrates a block diagram of an audio play operation of the low power audio play device 1000 according to an embodiment. FIG. 3 illustrates a view of a structure of a circular buffer 180 and an SRAM 280 shown in FIGS. 1 and 2.

Referring to FIGS. 2 and 3, audio data, e.g., audio data compressed into the MP3 file format, may be stored in a main storage unit 140. Audio data selected for playing may be provided to the buffer 150 through the bus 130.

According to a preferred embodiment, the buffer 150 may include a first buffer 160, a second buffer 170, and a circular buffer 180. The first and second buffers 160 and 170 may include a plurality of sectors in the same DRAM memory chip, or in the respectively different DRAM memory chips. However, the circular buffer 180 and the first and second buffers 160 and 170 are not limited to a specific form, and may be varied.

Audio data for playback, provided from the main storage unit 140, may be stored in the first buffer 160. The audio data stored in the first buffer 160 may be encoded with, e.g., an MP3 format (hereinafter, referred to as MP3 data) and/or various kinds of file formats such as Windows Media Audio (WMA), OGG, free lossless audio codec (FLAC), advanced audio coding (AAC), a waveform audio file format (WAV), etc. For convenience, MP3 data will be used as an example.

The MP3 data stored in the first buffer 160 may be provided for decoding to the CPU 110 through the bus 130. The CPU 110 may include an algorithm hardware or software for decoding MP3 data. The data decoded by the CPU 110 may be converted into PCM data. The PCM data decoded by the CPU 110 may be stored in the second buffer 170. The PCM data stored in the second buffer 170 may be stored in the circular buffer 180 through the DMA controller 120 and the bus 130 without passing through the CPU 110.

The circular buffer 180 may include a number M (for example, 3) of 128 KB data storage spaces. The circular buffer 180 may perform wrap around when a predetermined buffer size (for example, 128 KB*3 or 64 KB*6) is full with data. For example, referring to FIG. 3, when audio data of a 64 KB*3 size are stored in the circular buffer 180 of a 64 KB*6 size, assume that a write index indicates a region e in FIG. 3. In this case, the audio data of a 64 KB*2 size are stored in regions e and f, and the remaining data of 64 KB*1 are stored in a region a. When the audio data buffered in the circular buffer 180 reach a predetermined amount, they are provide to the audio output unit 200 through the DMA controller 120 and the bus 130 without passing through the CPU 110. In this data storing method, it appears that a starting point and an end point of the circular buffer 180 are connected to each other, such that audio data are provided to the audio output unit 200 seamlessly.

The audio output unit 200 may include an I2S device 210 and a SRAM 280. The I2S device 210 may include an internal DMA 220 and a FIFO 230. The I2S device 210 may have a connection with an audio output device (not shown) such as a speaker, an earphone, a headphone, etc., through an I2S interface method.

The SRAM 280 may store audio data provided from the circular buffer 180. The SRAM 280 in the audio output unit 200 may have a data storage capacity that is smaller than or identical to that of the circular buffer 180. For example, the SRAM 280 may have a data storage capacity of 128 KB.

In a preferred embodiment, the SRAM 280 may be divided into two data storage regions, each having a size of 64 KB. When audio data of 128 KB are filled in the SRAM 280 from the circular buffer 180, the audio processing unit 100 (i.e. hardware that is not directly related to playing or outputting the corresponding audio data) may be turned off. While the audio processing unit 100 is turned off, the audio data of the SRAM 180 may be provided to the FIFO 230 according to a control of the internal DMA 220. The audio data provided to the FIFO 230 may be played or outputted to the outside through an output device (such as a speaker, an earphone, a headphone, etc.) that is connected to the I2S device 210.

The audio processing unit 100 may maintain a turned-off state or may switch to a turned-on state according to a data output state of the SRAM 280 in the audio output unit 200. For example, after 64 KB audio data (corresponding to the half of 128 KB audio data stored in the SRAM 280) are played or outputted, power may be resupplied to the audio processing unit 100, such that the audio processing unit 100 receives audio data from the circular buffer 180. While a series of data transmission operations are performed between the SRAM 280 and the circular buffer 180, a data playing or outputting operation of the audio outputting unit 200 may be continuously performed. Moreover, after audio data are retransmitted to the SRAM 280, the audio processing unit 100 may be turned off again.

The above-described operation of turning on/off the audio processing unit 100 may be controlled by low power driving software loaded in the CPU 110. The low power driving software may be stored in, e.g., the main storage unit 140, which may include nonvolatile memories such as a flash memory. On performing a power-on operation of the audio play device 1000, it may be loaded into a working memory (not shown) in the CPU 110 or an internal memory, and may then be executed. The low power driving software may generate control commands to control an operation of the I2S device 210 in the audio output unit 200, and also may control turning on/off the audio processing unit 100. Although it will be described in more detail below, the low power driving software may generate a plurality of control commands before the turning off the audio processing unit 100. Thus, even when the audio processing unit 100 is turned off, operations to be performed on the I2S device 210 and turning on/off control operations of the audio processing unit 100 may be controlled according to a predetermined flow.

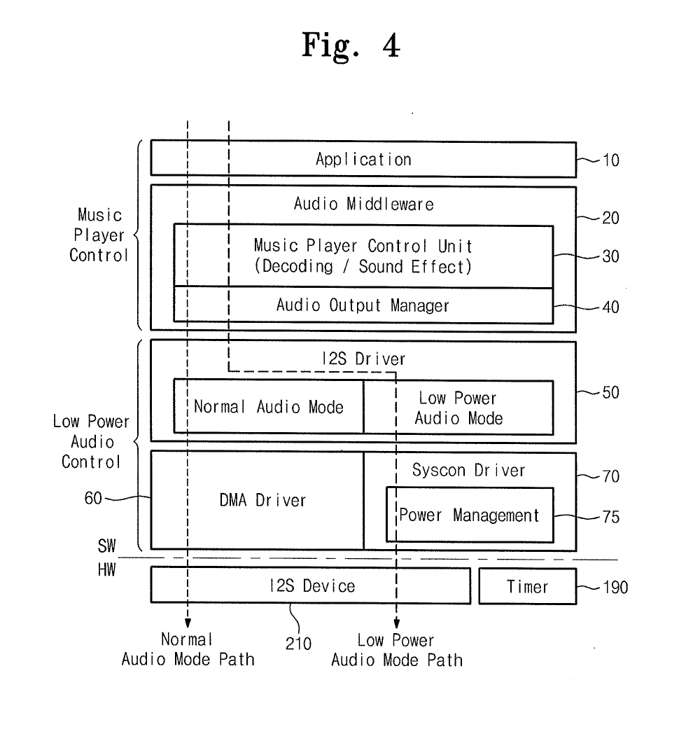

FIG. 4 illustrates a view of a hierarchical structure of low power driving software for implementing a method according to an embodiment.

Referring to FIG. 4, the low power driving software may be configured to perform a music player control function and a low power audio control function. The music player control function may be performed by an application layer 10 and an audio middleware layer 20. The application layer 10 and the audio middleware layer 20 may constitute an application platform.

The audio middleware layer 20 may include a music player control unit 20 and an audio output manager 40. The music player control unit 30 may process a decoding operation and sound effects on audio data to be played. The audio output manager 40 may control an operation for outputting a processed result of the decoding and sound effects, which are performed by the music player control unit 20.

The low power audio control function may be performed by an I2S driver 50, a DMA driver 60, and a system control SYSCON driver 70. The I2S driver 50, the DMA driver 60, and the system control SYSCON driver 70 may be configured as firmware. According to the present example embodiment, the I2S driver 50 is a driver that drives an operating mode as a normal power audio mode or a low power audio mode. Referring to FIG. 4, paths of audio data in the normal power audio mode and the low power audio mode are indicated with respective arrows. Unlike the normal power audio mode, the low power audio mode may partially turn off hardware that is not needed for operation, according to an operating state of the audio play device 1000. This turning on/off operation may be performed by controlling the power management unit 75 in the system control driver 70.

As will be described in more detail below, the low power audio control function performed according to the present example embodiment is not affected by an application platform and may control turning off/off the audio play device 1000 by its own function. With this configuration, regardless of the kind of application platform provided from various companies, a low power operation according to an embodiment can be performed.

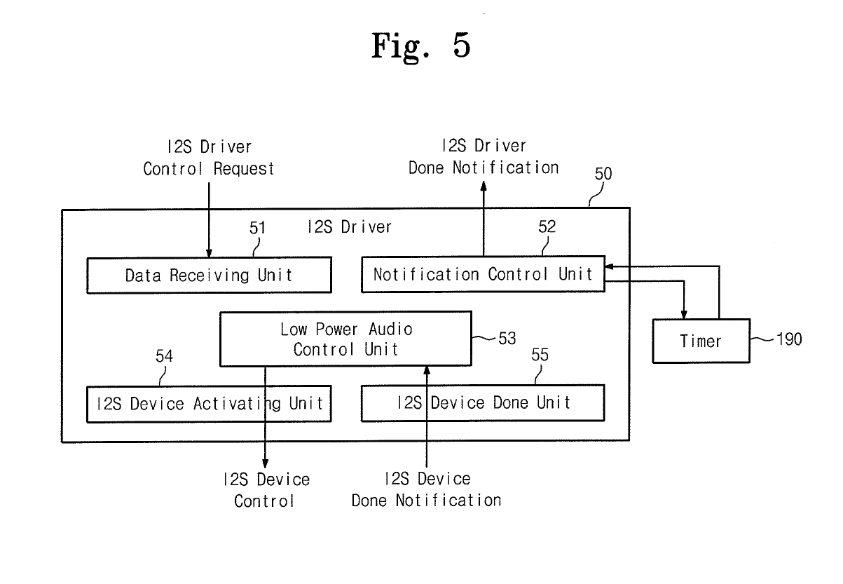

FIG. 5 illustrates a view of a detailed configuration of an I2S driver shown in FIG. 4.

Referring to FIG. 5, the I2S driver 50 may include a data receiving unit 51, a notification control unit 52, a low power audio control unit 53, an I2S device activation unit 54, and an I2S device done unit 55. Each of the function blocks 51 to 55 constituting the I2S driver 50 may be separated as an individual module for configuration thereof.

The data receiving unit 51 may be configured to receive audio data requested by a user from an application layer 10. The I2S device activation unit 54 and the I2S device done unit 55 may be configured to control an operation for buffering the received audio data and transmitting them to the I2S device 210, and for operation of audio data play of the I2S device 210.

According to an embodiment, the I2S device activation unit 54 and the I2S device done unit 55 may serve as a rendering control unit for providing the audio data buffered in the audio processing unit 100 to the audio output unit 200 and controlling an audio play operation performed in the audio output unit 200. According to the present example embodiment, the I2S device activation unit 54 and the I2S device done unit 55 do not immediately transmit the audio data provided from the application layer 10 to the I2S device 210, but rather control them to be buffered in the circular buffer 180. Also, the I2S device activation unit 54 and the I2S device done unit 55 control transmission of the buffered audio data to the I2S device 210 whenever the buffered audio data reaches a predetermined amount.

The notification control unit 52 may notify an upper layer (for example, the audio middleware 20) that a rendering operation for the buffered audio data is completed if the audio data buffered in the circular buffer 180 are transmitted to the I2S device 210. Here, the low power audio control unit 53 may be configured to turn off some hardware (i.e., hardware not directly related to the playing or outputting operation) during playing or outputting of the audio data transmitted to the I2S device 210.

In addition, the notification control unit 52 may periodically provide a notification signal to the upper layers 10 and 20 using a timer 190 in order to synchronize the currently playing audio data with the upper layers 10 and 20. As a result, synchronization can be achieved between, on the one hand, the audio data played after more than a predetermined amount is buffered and, on the other hand, data that the upper layers 10 and 20 recognize as being played.

For example, where the currently playing audio data are buffered for more than a predetermined amount and then played, an actual rending point of the buffered data may precede the occurrence point of a notification signal generated in the timer 190. According to an embodiment, by periodically providing the notification signal to the upper layers 10 and 20, the upper layers 10 and 20 perceive that audio data, which are actually buffered more than a predetermined amount and then played, are instead instantly rendered and played. According to this configuration, a low power audio play operation according to an embodiment becomes possible without a change of the upper layers 10 and 20.

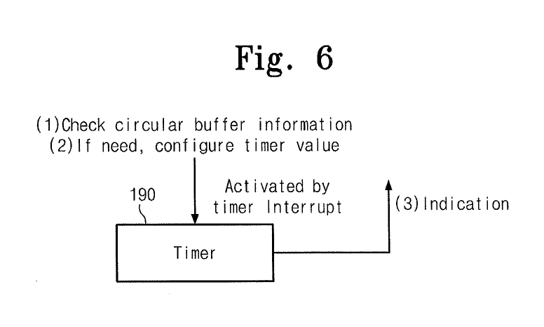

FIG. 6 illustrates a view of a notification signal occurrence operation of a timer 190 according to an embodiment.

Referring to FIGS. 5 and 6, the notification control unit 52 may analyze information of the audio data buffered in the circular buffer 180 in order to control an operation of the timer 190. Based on the analysis result of the information, the notification control unit 52 may change a setting value of the timer 190 if necessary. For example, according to a state that the data buffered in the circular buffer 180 are transmitted, a setting value of the timer 190 may be configured. Then, if a time interrupt is activated according to the setting value, the timer 190 may be configured to provide a notification signal to the upper layers 10 and 20.

According to the configuration of the low power audio play device 1000, synchronization between the actually playing audio data and data that the upper layers 10 and 20 recognize as being played can be achieved. Accordingly, while still using complex data and control flows of the upper layers 10 and 20, the low power audio play device 1000 may be effectively realized using the I2S driver 50 according to an embodiment.

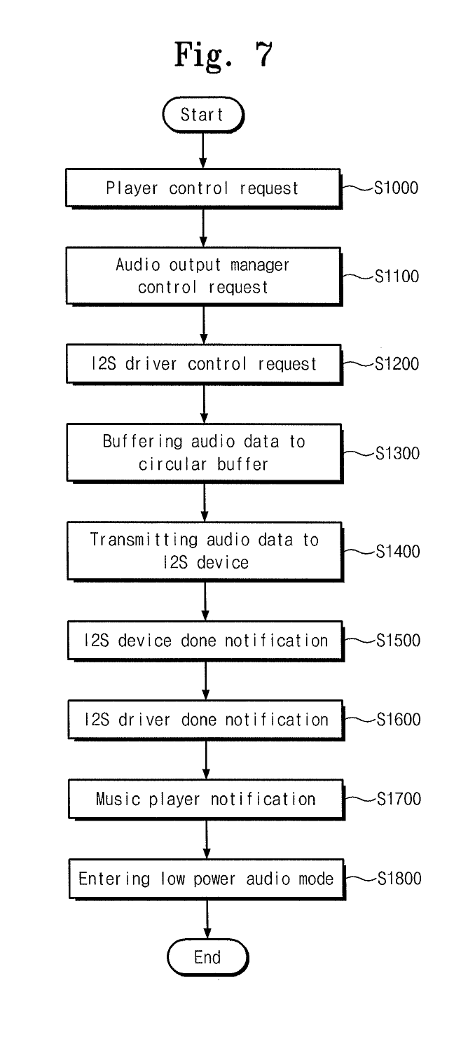

FIG. 7 illustrates a flowchart of a low power driving method of a low power audio play device 1000 according to an embodiment.

In operation S1000 of the example embodiment in FIG. 7, the application layer 10 generates an audio play control request (such as a request to play audio data made by a user) to the audio middleware layer 20. The audio play control request may be provided to the music player control unit 30 in the audio middleware layer 20. The music player control unit 30 processes decoding and sound effects on the audio data required from the application layer 10.

In operation S1100 of the example embodiment in FIG. 7, the music player control unit 30 generates an audio output manager control request to the audio output manager 40 in response to the audio play control request. In operation S1200 of the example embodiment in FIG. 7, then, the audio output manager 40 generates an I2S driver control request to the I2S driver 50 in response to the audio output manager control request.

The I2S driver 50 may perform an operation of a normal power audio mode or a low power audio mode in response to the I2S driver control request. For example, in case of the normal power audio mode, the I2S driver 50 may instantly transmit a decoding result of the audio data provided from the application layer 10 according to a user request. In this case, an additional control for supplying power to the audio processing unit 100 is not performed. In operation S1300 of the example embodiment in FIG. 7, in case of the low power audio mode, the I2S driver 50 may buffer a decoding result of the audio data provided from the application layer 10 according to a user request. Subsequent operations of the example embodiment in FIG. 7 are described below, following a description of an example operation of the buffer 180.

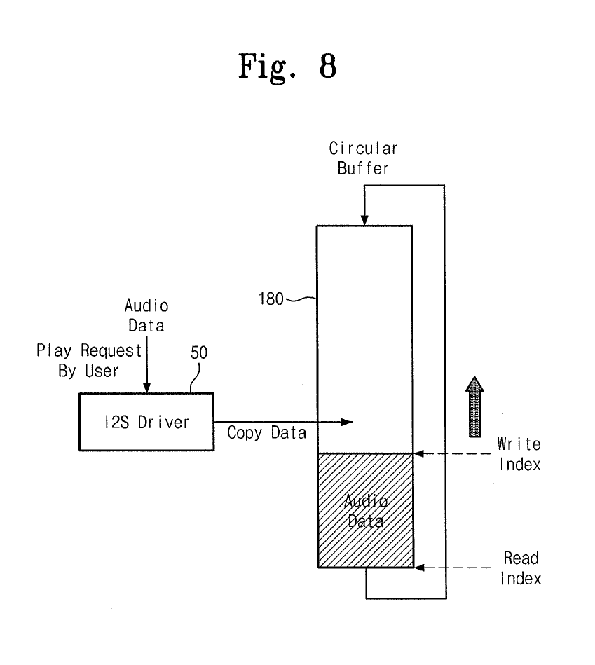

FIG. 8 illustrates a view of a method of buffering audio data in a circular buffer 180 in the operation S1300.

Referring to FIG. 8, if a request for playing audio data is transmitted from the application layer 10 by a user, a decoding result for the requested audio data may be stored in the circular buffer 180 according to a control of the I2S driver 50. A position of the data stored in the circular buffer 180 may be designated by a write index. After the decoding result is sequentially stored in the circular buffer 180 through the designated write index, the write index points to an initial position (for example, a) again. As a result, each time data are filled in the circular buffer 180 by a buffer size, the circular buffer 180 may perform wrap around.

Referring again to FIG. 7, in operation S1400, in response to a control of the I2S driver 50, the audio data buffered in the circular buffer 180 may be transmitted to the SRAM 280 of the audio output unit 200. In the present example embodiment, the transmission of the audio data from the circular buffer 180 to the SRAM 280 is performed each time the audio data buffered in the circular buffer are more than a predetermined amount.

After the audio data stored in the SRAM 280 are transmitted to the I2S device 210, the I2S device 210 may provide an I2S device done notification to the notification control unit 52 of the I2S driver 50 in operation S1500. Then, in operation S1600, the I2S driver 50 may provide an I2S driver done notification (representing that a rendering operation for corresponding audio data is completed) to the upper audio middleware layer 20.

In operation S1700 of the example embodiment in FIG. 7, the audio middleware layer 20 may notify a music player notification to the application layer 10 in response to the I2S driver done notification. Once the music player notification is provided to the application layer 10, power provided to the audio processing unit 100 is cut off and the audio processing unit 100 enters into a deep idle mode in operation S1800. As a result, the audio playing device 1000 may operate in a low power mode. In this case, hardware entering into the deep idle mode may be limited to the audio processing unit 100, i.e., hardware that is not directly related to an outputting or playing operation for audio data.

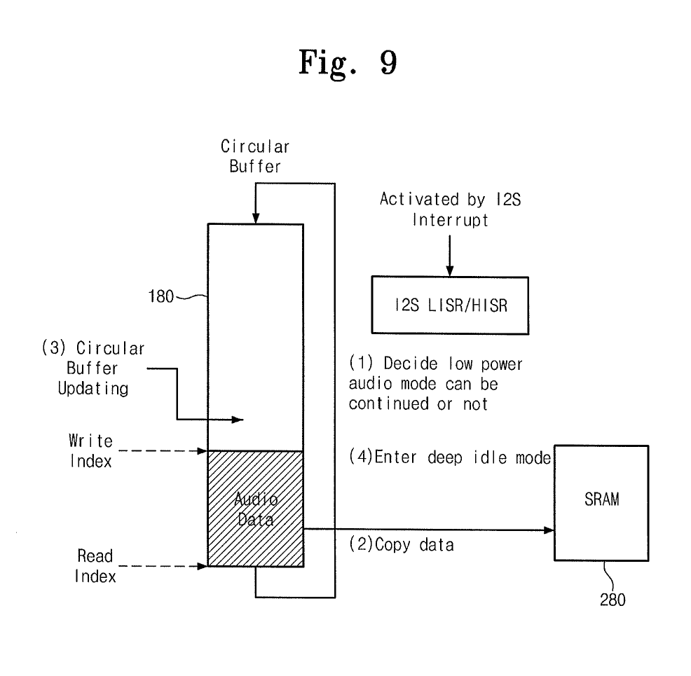

FIG. 9 illustrates a view of a method of transmitting audio data from the circular buffer 180 to the I2S device 210 in operation S1400 of FIG. 7.

In the example embodiment shown in FIG. 9, if audio data of more than a predetermined amount are buffered in the circular buffer 180, it is first determined whether the low power audio mode continues or not. Whether the low power audio mode continues or not may be determined by interrupt. The interrupt is a hardware mechanism that provides notification of an asynchronous event occurrence to the CPU 110. An interrupt may occur through an interrupt service routine (ISR). According to an embodiment, in order to generate an interrupt that represents whether a low power audio mode continues or not, an I2S low level ISR (LISR) or a high level ISR (HISR) may be used.

The interrupt may occur based on a remaining capacity of the SRAM 280. For example, after more than a half of the audio data stored in the SRAM 180 are played or outputted (that is, a remaining capacity of the SRAM 240 is less than ½), the I2S LISR/HISR may be executed to stop the low power audio mode. If less than a half of the audio data stored in the SRAM 280 are played or outputted (that is, if a remaining capacity of the SRAM 280 are more than ½), the low power audio mode may continue. It will be appreciated that a remaining capacity of the SRAM 280= 1/2 is merely used as an example as a reference value for interrupt occurrence. This is just one example, and the reference value for interrupt occurrence may vary. Moreover, if the low power audio mode continues, I2S LISR/HISR may be configured not to be additionally executed.

In the present example embodiment, if the low power audio mode needs to be stopped based on the determination result, power is resupplied to the audio processing unit 100 in response to an I2S interrupt. Then, audio data may be additionally supplied from the circular buffer 180 of the audio processing unit 100 to the SRAM 280. Simultaneously, new audio data may be buffered in an empty data storage region of the circular buffer 180.

The above mentioned low power driving method of the low power audio play device 1000 is not subject to an application platform, and may be used to control power of the audio play device by its own function. Accordingly, low power consumption of the audio play device may be easily achieved without changing hardware of a typical audio play device.

As described above, embodiments relate to a low power audio play device and method for minimizing power consumption when audio data are played. Embodiments also relate to a low power audio play device and method that are not subject to application platforms (that is, are not dependant on application platforms), but instead control power of the audio play device by their own function.

Audio play devices are being developed into an all-around audio player with various additional features. For example, an audio play device may be loaded into a digital broadcasting receiver, a mobile communication terminal, etc., such that they can additionally provide an audio play function besides their original functions (for example, a digital broadcasting receiving function and a mobile communication function). As portable electronic devices such as a mobile communication terminal commonly incorporate an audio play device, a way of minimizing power consumption while the audio play device plays audio data may be needed.

According to an embodiment, after buffering audio data of a predetermined amount, power for hardware that is not directly related to playing the buffered audio data can be off. Accordingly, power consumption of an audio play device can be minimized. Further, a power management method according to an embodiment may be used to control power of an audio play device by its own function without being subject to application platform. Accordingly, without changing hardware of a typical audio play device, low power consumption of an audio play device may be achieved.

Example embodiments have been disclosed herein, and although specific terms are employed, they are used and are to be interpreted in a generic and descriptive sense only and not for purpose of limitation. For example, according to an embodiment, an audio play device adopting as a main storage a flash memory among semiconductor memories will be described as one example. However, this is just one example and a storage device and its data storing method according to an embodiment is not limited to audio play devices of specific forms and thus may be applied to various forms of audio and video play devices. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A low power audio play device, comprising:
an audio processing unit configured to decode requested audio data, the audio processing unit buffering decoded requested audio data as buffered data; and
an audio output unit configured to play the buffered data when the buffered data in the audio processing unit are more than a predetermined amount,
wherein a supply of power to hardware is configured to be cut off, except for power supplied to the audio output unit, while the buffered data are played.

2. The low power audio play device as claimed in claim 1, wherein the audio processing unit is configured to periodically generate a notification signal per a predetermined period and synchronize the requested audio data with audio data played through the audio output unit.

3. The low power audio play device as claimed in claim 1, wherein the audio processing unit comprises:
a main storage unit configured to store audio data;
a central processing unit configured to receive the requested audio data from the main storage unit, the central processing unit decoding the received requested audio data; and
a buffer configured to buffer the decoded requested audio data according to a control of the central processing unit, the buffer providing the buffered data to the audio output unit when the buffered data are more than a predetermined amount,
wherein power supplied to the audio processing unit is cut off when the buffered data are provided from the buffer to the audio output unit.

4. The low power audio play device as claimed in claim 3, wherein the audio processing unit further comprises a direct memory access (DMA) controller, the DMA controller being configured to control provision of the buffered data to the audio output unit without passing the buffered data through the central processing unit.

5. The low power audio play device as claimed in claim 3, wherein the central processing unit comprises:
a driver configured to control to play of the buffered data according to an operating mode, the operating mode including a normal power audio mode and a low power audio mode; and
a power management unit, the power management unit being configured to cut off the supply of power to hardware unrelated to audio playing according to a control of the driver while the buffered data are played in the low power audio mode.

6. The low power audio play device as claimed in claim 5, wherein the driver comprises:
a data receiving unit configured to receive the requested audio data from an application layer, the application layer being a layer upper to the driver;
a rendering control unit configured to provide the buffered data to the audio output unit after a predetermined amount of the requested audio data that is provided from the application layer is buffered;
a notification control unit configured to periodically provide a notification signal to the application layer per a predetermined period while the buffered data are played through the audio output unit; and
a low power audio control unit for controlling a power supply operation of the power management unit according to the operating mode.

7. The low power audio play device as claimed in claim 6, wherein the notification control unit is configured to analyze the data buffered in the buffer and change a setting value of a time based on an analysis result, the notification signal being provided to the application layer according to the setting value.

8. The low power audio play device as claimed in claim 3, wherein the buffer comprises a circular buffer.

9. The low power audio play device as claimed in claim 3, wherein the audio output unit comprises an output data storage unit, the output data storage unit being configured to receive the buffered data from the buffer and store the buffered data.

10. The low power audio play device as claimed in claim 9, wherein, when a remaining capacity of data stored in the output data storage unit is less than a reference value, power is resupplied to the audio processing unit.

11. The low power audio play device as claimed in claim 9, wherein, when a remaining capacity of data stored in the output data storage unit is less than a reference value, data buffered in the buffer are additionally provided to the output data storage unit.

12. The low power audio play device as claimed in claim 11, wherein, after the buffered data are additionally provided from the buffer to the output data storage unit, power supplied to the audio processing unit is cut off.

13. A low power audio play method, the method comprising:
decoding requested audio data;
buffering the decoded requested audio data as buffered data;
playing the buffered data if the buffered data is more than a predetermined amount; and
cutting off power supply of a hardware region irrelevant to the playing operation among a plurality of hardware regions in the audio play device while the buffered data are played.

14. The method as claimed in claim 13, further comprising:
changing a setting value of a timer by analyzing the buffered data; and
periodically generating a notification signal to an application layer per a predetermined period through the timer while the buffered data are played.

15. The method as claimed in claim 14, wherein the cutting off of the power supply of the hardware region is performed by a control of a driver layer, the driver layer being lower than an application layer.

16. The method as claimed in claim 13, wherein the playing of the buffered data comprises:
storing the buffered data in an audio output unit when the buffered data is more than a predetermined amount; and
playing the data stored in the audio output unit,
wherein power supply is cut off to hardware, except the audio output unit, while the buffered data are played.

17. The method as claimed in claim 13, further comprising:
when a remaining capacity of data stored in the output data storage unit is less than a reference value, re-supplying power to hardware to which the power supply had been previously cut off; and
providing additional buffered data from the buffer to the audio output unit, wherein, after the additional buffered data are provided from the buffer to the audio output unit, power supply to hardware, except the audio output unit, is cut off again.

18. A low power audio play method, the method comprising;
decoding audio data in response to a request generated through an application layer according to a user request;
buffering a decoding result in a circular buffer;
storing the buffered data in an audio output unit when the data buffered in the circular buffer are more than a predetermined amount;
periodically providing a notification signal to an audio middleware layer and the application layer, the notification signal representing that a rendering operation about the data stored in the audio output unit is completed;
cutting off power supply to hardware except the audio output unit; and
playing the data stored in the audio output unit.

19. The method as claimed in claim 18, further comprising:
changing a setting value of a timer by analyzing the buffered data; and
periodically generating the notification signal to the audio middleware layer and the application layer through the timer while the buffered data are played.

20. A low power audio play device, comprising:
a decoding means for decoding audio data in response to a request generated through an application layer according to a user request;
a buffering means for buffering a decoding result in a circular buffer;
a storage means for storing the buffered data in an audio output unit when the data buffered in the circular buffer are more than a predetermined amount;
a notification means for periodically providing a notification signal to an audio middleware layer and the application layer, the notification signal representing that a rendering operation for the data stored in the audio output unit is completed;
a power supply control means for cutting off power supply to hardware except the audio output unit; and
a playing means for playing the data stored in the audio output unit.
